(19) United States
(12) Patent Application Publication
(10) Pub. No.: US 2008/0304201 A1
(43) Pub. Date: Dec. 11, 2008

(54) VOLTAGE SIGNAL CONVERTER CIRCUIT AND MOTOR

(75) Inventors: Nobuhiro Takao, Kyoto (JP); Tsuneki Takagi, Kyoto (JP)

Correspondence Address: NIDEC CORPORATION;c/o KEATING & BENNETT, LLP, 1800 Alexander Bell Drive, SUITE 200, Reston, VA, 20191, US

(73) Assignee: NIDEC CORPORATION, Minami-ku (JP)

(21) Appl. No.: 12/134,461

(22) Filed: Jun. 6, 2008

(30) Foreign Application Priority Data
Jun. 8, 2007 (JP) 2007-152372

(51) Int. Cl. G01P 1/00

(52) U.S. Cl. 361/240

(57) ABSTRACT

In a voltage signal converter circuit, a peak hold circuit, which is configured with an operational amplifier, a diode, and a capacitor, receives a sensor voltage signal and outputs a peak voltage signal. A bottom hold circuit, which is configured with an operational amplifier, a diode, and a capacitor, receives a sensor voltage signal and outputs a bottom voltage signal. An intermediate voltage signal generator circuit receives the peak voltage signal and the bottom voltage signal and generates an intermediate voltage signal having an intermediate value between a peak voltage value and a bottom voltage value. A comparator generates an accurate rectangular wave voltage signal having a duty ratio equal to 50% in accordance with a magnitude correlation between a sensor voltage value and an intermediate voltage value.

### BACKGROUND OF THE INVENTION

1. Field of the Invention

The present invention relates to a magnetoresistive sensor system for accurately measuring a motor driving speed even in a case where the motor driving speed is low.

2. Description of the Related Art

There has been provided a magnetoresistive sensor system for measuring a motor driving speed. FIG. 10 is a schematic view of a conventional magnetoresistive sensor system. A sensor magnet 1 is mounted coaxially with a motor rotor to rotate integrally with the motor rotor. The sensor magnet 1 has a substantially circular disk shape and is provided with a plurality of magnetic poles on an outer peripheral surface thereof.

A magnetoresistive element 10A is connected to an end to which a constant-voltage power supply applies a constant voltage, while a magnetoresistive element 10B is connected to a grounding end. The magnetoresistive sensor system generates a sensor voltage signal at a connection point between the magnetoresistive elements 10A and 10B, and generates a rectangular wave voltage signal in a voltage signal converter circuit. Brief description is given below of the sensor voltage signal and the rectangular wave voltage signal.

While the sensor magnet 1 rotates integrally with the motor rotor, magnitudes of magnetic fields sensed respectively by the magnetoresistive elements 10A and 10B are periodically varied. Accordingly, resistance values of the magnetoresistive elements 10A and 10B are also periodically varied, and a voltage value of a sensor voltage signal is also periodically varied.

The voltage signal converter circuit receives a sensor voltage signal and converts the input sensor voltage signal to a rectangular wave voltage signal. While the voltage value of the sensor voltage signal is periodically varied, the corresponding rectangular wave voltage signal adopts a voltage value of a High level or of a Low level alternately on a periodic basis. A motor system provided with a motor and a magnetoresistive sensor system is capable of measuring a motor driving speed by measuring a duration of the High level or the Low level adopted as the voltage value of the rectangular wave voltage signal, so that a motor current value can be set at an appropriate timing.

Each of FIGS. 11 and 12 shows a conventional voltage signal converter circuit. In the voltage signal converter circuit shown in FIG. 11, a sensor voltage signal is generated at a connection point X between magnetoresistive elements 10A and 10B. Further, there is generated at a connection point Y between resistors 12A and 12B an intermediate voltage signal having a voltage value equal to one-half a constant voltage value applied by a constant-voltage power supply. Inputted to a non-inverting input terminal of a comparator 14 are an alternate current component of the sensor voltage signal through a capacitor 11 and the intermediate voltage signal through a resistor 13. Further, the intermediate voltage signal is input to an inverting input terminal of the comparator 14. Accordingly, there is generated at an output terminal of the comparator 14 a rectangular wave voltage signal reflecting the alternate current component of the sensor voltage signal and having a duty ratio equal to 50%.

In the voltage signal converter circuit shown in FIG. 12, a sensor voltage signal is generated at a connection point X between magnetoresistive elements 10A and 10B. Further, there is generated at a connection point Z among a resistor 15 and capacitors 16A and 16B only a direct current component of the sensor voltage signal because of a delay effect by the resistor and the capacitors. The sensor voltage signal is input to a non-inverting input terminal of a comparator 17, and the direct current component of the sensor voltage signal is input to an inverting input terminal of the comparator 17. Accordingly, there is generated at an output terminal of the comparator 17 a rectangular wave voltage signal reflecting the direct current component of the sensor voltage signal and having a duty ratio equal to 50%.

However, none of such conventional voltage signal converter circuits can accurately measure a motor driving speed in a case where the motor driving speed is low. Thus, a motor current value cannot be set at an appropriate timing.

In the voltage signal converter circuit shown in FIG. 11, a frequency of the sensor voltage signal is low when a motor driving speed is low, so that an impedance of the capacitor 11 is increased. Accordingly, the alternate current component of the sensor voltage signal, which is input to the non-inverting input terminal of the comparator 14, is decreased. As a result, a rectangular wave voltage signal having a duty ratio equal to 50% tends not to be generated.

In the voltage signal converter circuit shown in FIG. 12, a frequency of the sensor voltage signal is low when a motor driving speed is low, so that a cycle of the sensor voltage signal is made longer than a delay time due to the resistor 15 and the capacitors 16A and 16B. Therefore, a voltage signal input to the inverting input terminal of the comparator 17 will include not only the direct current component of the sensor voltage signal but also an alternate current component thereof. As a result, a rectangular wave voltage signal having a duty ratio equal to 50% tends not to be generated.

### SUMMARY OF THE INVENTION

In view of the foregoing problems, a voltage signal converter circuit according to a preferred embodiment of the present invention includes a peak hold circuit, a bottom hold circuit, an intermediate voltage signal generator circuit, and a rectangular wave voltage signal generator circuit. The peak hold circuit adopts a maximum of a voltage value of a sensor voltage signal input from a magnetoresistive sensor and outputs a peak voltage signal having a voltage value equal to the maximum. The bottom hold circuit adopts a minimum of the voltage value of the sensor voltage signal input from the magnetoresistive sensor and outputs a bottom voltage signal having a voltage value equal to the minimum. The intermediate voltage signal generator circuit outputs an intermediate voltage signal having a voltage value equal to an average between the voltage value of the peak voltage signal input from the peak hold circuit and the voltage value of the bottom voltage signal input from the bottom hold circuit. The rectangular wave voltage signal generator circuit outputs a rectangular wave voltage signal in accordance with a magnitude correlation between the voltage value of the sensor voltage signal input from the magnetoresistive sensor and the voltage value of the intermediate voltage signal input from the intermediate voltage signal generator circuit.

According to such a configuration, it is possible to accurately measure a motor driving speed even in a case where the motor driving speed is low.

Other features, elements, advantages and characteristics of the present invention will become more apparent from the following detailed description of preferred embodiments thereof with reference to the attached drawings.

### BRIEF DESCRIPTION OF THE DRAWINGS

FIG. 1A is a schematic view of a magnetoresistive sensor system according to a preferred embodiment of the present invention.

FIG. 1B is a pattern diagram showing a variation in positional relation between magnetoresistive elements and a sensor magnet in the magnetoresistive sensor system according to a preferred embodiment of the present invention.

FIG. 1C is a graph showing a variation in voltage value of a sensor voltage signal due to driving of a motor.

FIG. 2 is a diagram showing a voltage signal converter circuit according to a First Configuration Example of a preferred embodiment of the present invention.

FIG. 3 is a diagram showing a voltage signal converter circuit according to a Second Configuration Example of a preferred embodiment of the present invention.

FIG. 4 is a diagram showing an intermediate voltage signal generator circuit according to the First Configuration Example of a preferred embodiment of the present invention.

FIG. 5 is a diagram showing an intermediate voltage signal generator circuit according to the Second Configuration Example of a preferred embodiment of the present invention.

FIG. 6 is a diagram showing an intermediate voltage signal generator circuit according to a Third Configuration Example of a preferred embodiment of the present invention.

FIG. 7 is a diagram showing an intermediate voltage signal generator circuit according to a Fourth Configuration Example of a preferred embodiment of the present invention.

FIG. 8 is a graph showing variations of voltage signals due to driving of the motor.

FIG. 9 is another graph showing variations of voltage signals due to driving of the motor.

FIG. 10 is a schematic view of a conventional magnetoresistive sensor system.

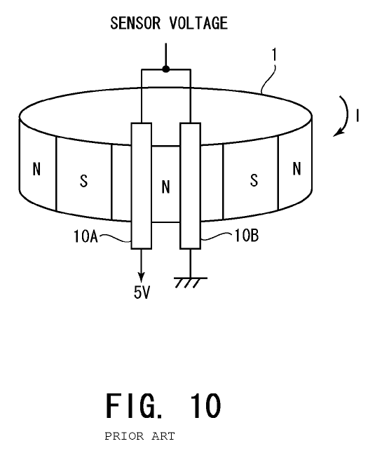

FIG. 11 is a diagram showing a conventional voltage signal converter circuit.

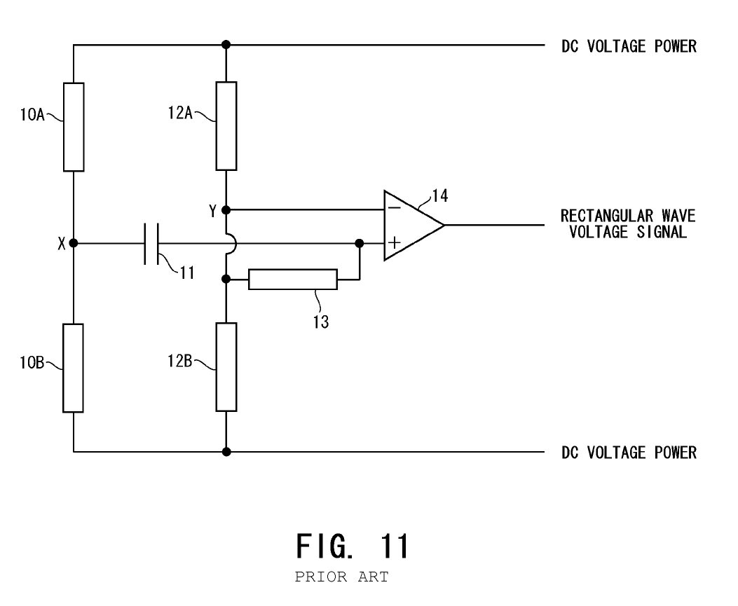

FIG. 12 is a diagram showing another conventional voltage signal converter circuit.

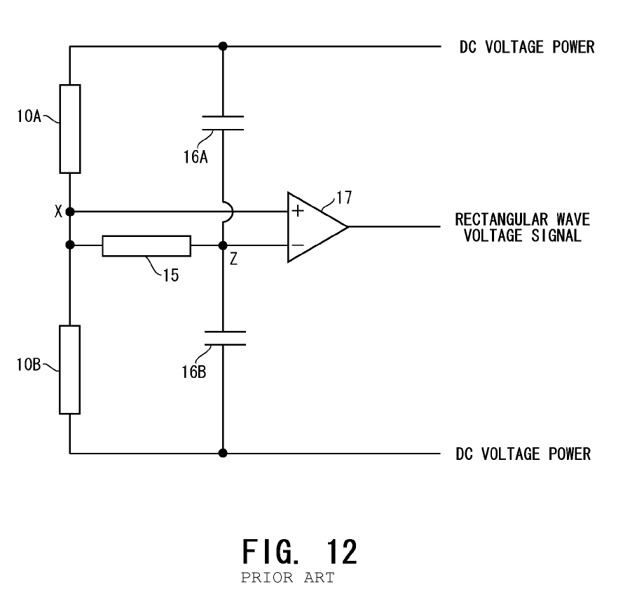

### DETAILED DESCRIPTION OF PREFERRED EMBODIMENTS

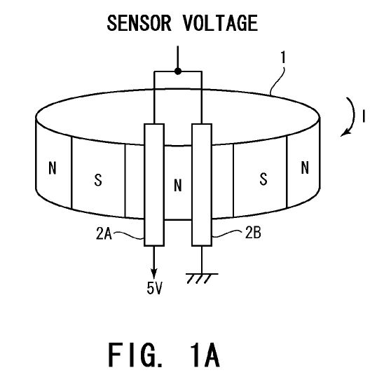

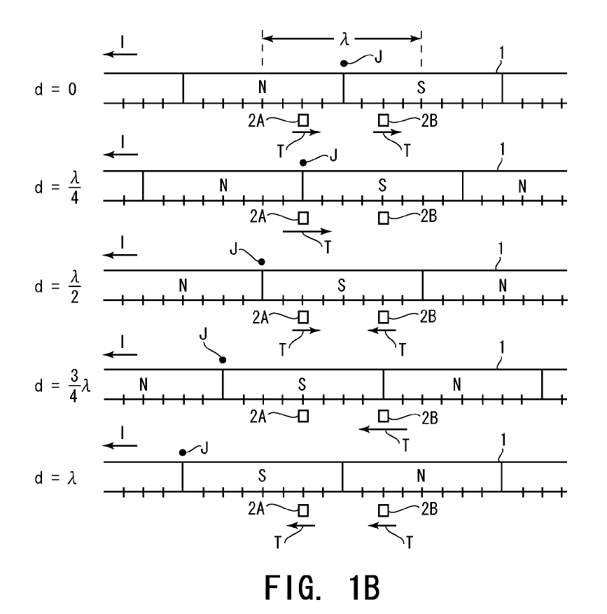

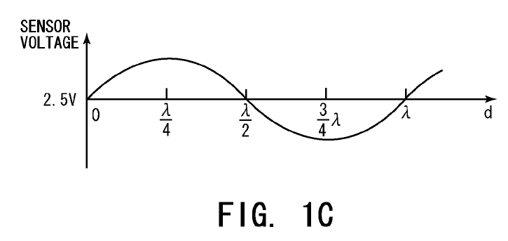

Referring to FIGS. 1A through 9, preferred embodiments of the present invention will be described in detail. It should be noted that in the explanation of the preferred embodiments of the present invention, when positional relationships among and orientations of the different components are described as being up/down or left/right, ultimately positional relationships and orientations that are in the drawings are indicated; positional relationships among and orientations of the components once having been assembled into an actual device are not indicated. Meanwhile, in the following description, an axial direction indicates a direction parallel or substantially parallel to a rotation axis, and a radial direction indicates a direction perpendicular or substantially perpendicular to the rotation axis.

### Outline of the Magnetoresistive Sensor System

FIG. 1A is a schematic view of a magnetoresistive sensor system. A sensor magnet 1 is mounted coaxially with a motor rotor, and rotates integrally with the motor rotor while a motor is driven. The sensor magnet 1 rotates in a direction indicated by an arrow I. The sensor magnet 1 preferably has a substantially circular disk shape and is provided with a plurality of magnetic poles on an outer peripheral surface thereof. In FIG. 1A, the outer peripheral surface of the sensor magnet 1 has N poles and S poles denoted respectively by symbols N and S.

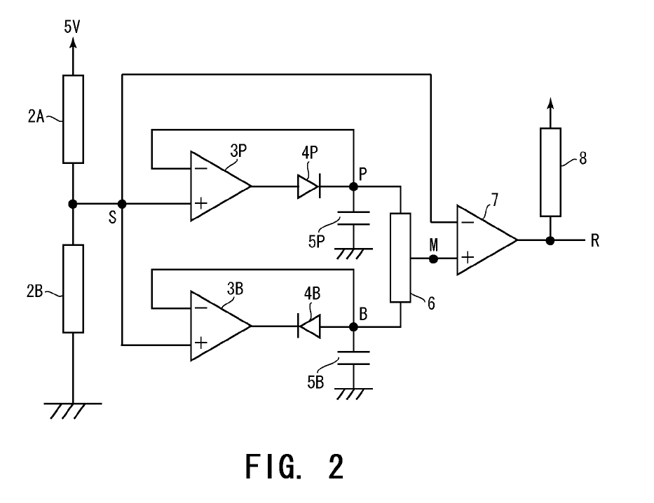

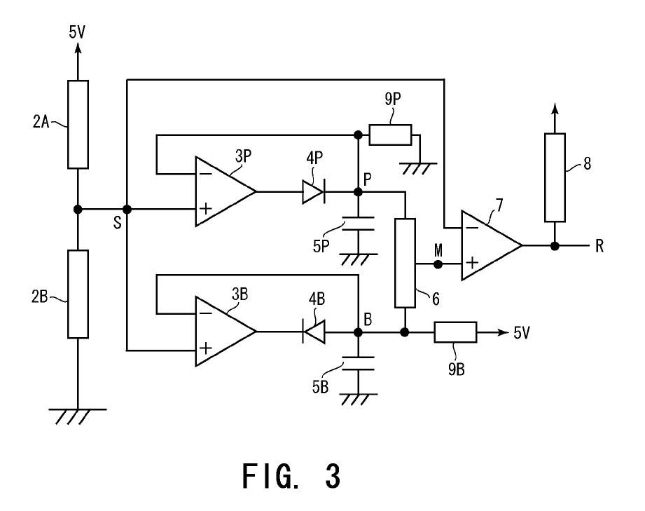

Magnetoresistive elements 2A and 2B are fixed in the vicinity of the sensor magnet 1 while a space is provided between the magnetoresistive elements 2A and 2B such that the space is equal to half a width (a distance between a center of an N pole and a center of an S pole adjacent thereto) of the magnetic pole of the sensor magnet 1. The magnetoresistive element 2A is connected to an end to which a constant-voltage power supply applies a constant voltage, while the magnetoresistive element 2B is connected to a grounding end. In the present preferred embodiment, a constant voltage equal to about 5 V, for example, preferably is applied by the constant-voltage power supply. There is generated a sensor voltage signal at a connection point between the magnetoresistive elements 2A and 2B, and the sensor voltage signal is input to a voltage signal converter circuit illustrated in FIG. 2 or 3. Described below is a method for generating a sensor voltage signal.

FIG. 1B is a diagram showing a variation in positional relationship between the sensor magnet 1 and the magnetoresistive elements 2A and 2B. In FIG. 1B, there is shown the outer peripheral surface of the sensor magnet 1 expanded on a plane. Also shown are pattern cross-sections of the magnetoresistive elements 2A and 2B. There is further shown a distance d traveled by one point J on the outer peripheral surface of the sensor magnet 1 from an initial state as shown on a first line of FIG. 1B by using a magnetic pole width λ as a measurement. The point J on the outer peripheral surface of the sensor magnet 1 is indicated by a dot. While the distance d is increased by driving of the motor, the outer peripheral surface of the sensor magnet 1 rotates in the direction indicated by the arrow I, but none of the magnetoresistive elements 2A and 2B move.

Each of the magnetoresistive elements 2A and 2B may exert any one of a negative magnetoresistive effect and a positive magnetoresistive effect. Hereinafter, the present preferred embodiment is to be described with an assumption that each of the magnetoresistive elements 2A and 2B exerts a negative magnetoresistive effect. In a case where each of the magnetoresistive elements 2A and 2B exerts a negative magnetoresistive effect, a resistance value of each of the magnetoresistive elements 2A and 2B is decreased when a horizontal component of a magnetic field sensed by each of the magnetoresistive elements 2A and 2B is large. In FIG. 1B, a magnitude and a direction of the horizontal component of the magnetic field sensed by each of the magnetoresistive elements 2A and 2B are indicated by an arrow T in the vicinity of each of the magnetoresistive elements 2A and 2B. In this case, lines of magnetic force in the vicinity of the outer peripheral surface of the sensor magnet 1 are distributed mainly from a center of an N pole to a center of an S pole adjacent thereto.

In a state where the distance d is equal to zero, the horizontal components of the magnetic fields sensed respectively by the magnetoresistive elements 2A and 2B are equal to each other in magnitude and direction. Therefore, the magnetoresistive elements 2A and 2B have resistance values equal to each other, and the sensor voltage signal has a voltage value equal to about 2.5 V, for example.

In a state where the distance d is equal to about λ/4, for example, the horizontal component of the magnetic field sensed by the magnetoresistive element 2A is larger than the horizontal component of the magnetic field sensed by the magnetoresistive element 2B. Therefore, the magnetoresistive element 2A has a resistance value smaller than that of the magnetoresistive element 2B, and the sensor voltage signal has a voltage value larger than approximately 2.5 V, for example.

In a state where the distance d is equal to about λ/2, for example, the horizontal components of the magnetic fields sensed respectively by the magnetoresistive elements 2A and 2B are equal to each other in magnitude but are opposite to each other in direction. Therefore, the magnetoresistive elements 2A and 2B have resistance values equal to each other, and the sensor voltage signal has a voltage value equal to about 2.5 V, for example.

In a state where the distance d is equal to about 3λ/4, for example, the horizontal component of the magnetic field sensed by the magnetoresistive element 2A is smaller than the horizontal component of the magnetic field sensed by the magnetoresistive element 2B. Therefore, the magnetoresistive element 2A has a resistance value larger than that of the magnetoresistive element 2B, and the sensor voltage signal has a voltage value smaller than about 2.5 V, for example.

In a state where the distance d is equal to λ, the horizontal components of the magnetic fields sensed respectively by the magnetoresistive elements 2A and 2B are equal to each other in magnitude and direction. Therefore, the magnetoresistive elements 2A and 2B have resistance values equal to each other, and the sensor voltage signal has a voltage value equal to about 2.5 V, for example.

FIG. 1C is a graph showing a variation in voltage values of the sensor voltage signal. While the motor is driven, the voltage value of the sensor voltage signal is varied within a constant amplitude in a cycle equal to a time length required for the point J on the outer peripheral surface of the sensor magnet 1 to travel a distance equal to the magnetic pole width λ. FIG. 1C shows the variation in voltage values of the sensor voltage signal by a sinusoidal wave. However, in many cases, the variation in voltage values of the sensor voltage signal cannot be shown by a sinusoidal wave because of the shapes of the sensor magnet 1 as well as the magnetoresistive elements 2A and 2B. The preferred embodiments of the present invention are applicable even to such a case since the voltage value of the sensor voltage signal is varied within the constant amplitude in the cycle equal to the time length required for the point J on the outer peripheral surface of the sensor magnet 1 to travel the distance equal to the magnetic pole width λ.

### Configuration of the Voltage Signal Converter Circuit

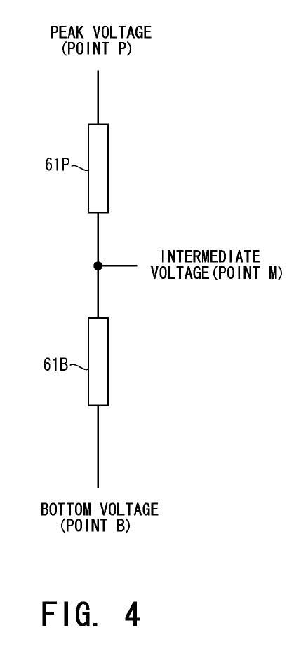

FIG. 2 is a diagram showing a voltage signal converter circuit according to a First Configuration Example, and FIG. 3 is a diagram showing a voltage signal converter circuit according to a Second Configuration Example. A magnetoresistive sensor is configured with magnetoresistive elements 2A and 2B. A peak hold circuit is configured with an operational amplifier 3P, a diode 4P, and a capacitor 5P. A bottom hold circuit is configured with an operational amplifier 3B, a diode 4B, and a capacitor 5B. An intermediate voltage signal generator circuit 6 may be any one of those according to a First to a Fourth Configuration Example respectively illustrated in FIGS. 4 to 7. A rectangular wave voltage signal generator circuit is configured with a comparator 7 and a resistor 8.

Resistors 9P and 9B are constituents, which are included in the voltage signal converter circuit according to the Second Configuration Example shown in FIG. 3, for appropriately controlling the voltage signal converter circuit even in a case where a temperature is gradually varied in a motor system provided with a magnetoresistive sensor system according to the present preferred embodiment and a motor. These constituents will be described below in detail. In the following, description is given to a magnetoresistive sensor, the peak hold circuit, the bottom hold circuit, the intermediate voltage signal generator circuit 6, and the rectangular wave voltage signal generator circuit. These circuits are common in the voltage signal converter circuits according to the First and Second Configuration Examples respectively shown in FIGS. 2 and 3.

The magnetoresistive sensor is identical to that shown in FIG. 1. Specifically, the magnetoresistive element 2A is connected to an end to which a constant-voltage power supply applies a constant voltage, while the magnetoresistive element 2B is connected to a grounding end. At a connection point between the magnetoresistive elements 2A and 2B, a sensor voltage signal is output, which has the variation illustrated in FIG. 1C.

The peak hold circuit adopts a maximum of the voltage value of the sensor voltage signal input at a point S, and outputs at a point P a peak voltage signal having a voltage value equal to the maximum. Thus, in a case where the voltage value of the sensor voltage signal being input to the peak hold circuit is larger than the voltage value of the peak voltage signal currently output from the peak hold circuit, the voltage value of the peak voltage signal is replaced with the voltage value of the sensor voltage signal. On the other hand, in a case where the voltage value of the sensor voltage signal being input to the peak hold circuit is smaller than the voltage value of the peak voltage signal currently output from the peak hold circuit, the voltage value of the peak voltage signal is not updated.

As shown in FIG. 1C, the voltage value of the sensor voltage signal is periodically varied within a constant amplitude in correspondence with an increase in the distance d traveled by the point J on the outer peripheral surface of the sensor magnet 1. Accordingly, the voltage value of the peak voltage signal is kept at the maximum of the voltage value of the sensor voltage signal while the motor is steadily driven. Described below are the constituents of the peak hold circuit.

The operational amplifier 3P receives a sensor voltage signal at a non-inverting input terminal thereof. The operational amplifier 3P has already received a peak voltage signal at an inverting input terminal thereof. Thus, the operational amplifier 3P would define a voltage follower circuit in a case where the diode 4P is not provided. In this case, the operational amplifier 3P would consistently replace the voltage value of the peak voltage signal with a voltage value of a new sensor voltage signal.

However, there is interposed, at a negative feedback portion of the operational amplifier 3P, the diode 4P which sets a direction of rectification to a forward direction with respect to a direction of input to the inverting input terminal of the operational amplifier 3P. Thus, the negative feedback portion of the operational amplifier 3P is conductive only in a case where the voltage value of the sensor voltage signal being input to the operational amplifier 3P is larger than the voltage value of the peak voltage signal already input to the operational amplifier 3P. In this case, the voltage value of the peak voltage signal is replaced with the voltage value of the sensor voltage signal.

The capacitor 5P has a first electrode connected to the point P, and a second electrode connected to a grounding end. The capacitor 5P accumulates electric charges in correspondence with the voltage value of the peak voltage signal. Therefore, while the motor is steadily driven, the voltage value of the peak voltage signal can be kept at the maximum of the voltage value of the sensor voltage signal.

The bottom hold circuit adopts a minimum of the voltage value of the sensor voltage signal input at the point S, and outputs at a point B a bottom voltage signal having a voltage value equal to the minimum. Thus, in a case where the voltage value of the sensor voltage signal being input to the bottom hold circuit is smaller than the voltage value of the bottom voltage signal currently output from the bottom hold circuit, the voltage value of the bottom voltage signal is replaced with the voltage value of the sensor voltage signal. On the other hand, in a case where the voltage value of the sensor voltage signal being input to the bottom hold circuit is larger than the voltage value of the bottom voltage signal currently output from the bottom hold circuit, the voltage value of the bottom voltage signal is not updated.

As shown in FIG. 1C, the voltage value of the sensor voltage signal is periodically varied within the constant amplitude in correspondence with an increase in the distance d traveled by the point J on the outer peripheral surface of the sensor magnet 1. Accordingly, the voltage value of the bottom voltage signal is kept at the minimum of the voltage value of the sensor voltage signal while the motor is steadily driven. Described below are constituents of the bottom hold circuit.

The operational amplifier 3B receives a sensor voltage signal at a non-inverting input terminal thereof. The operational amplifier 3B has already received a bottom voltage signal at an inverting input terminal thereof. Thus, the operational amplifier 3B would define a voltage follower circuit in a case where the diode 4B is not provided. In this case, the operational amplifier 3B would consistently replace the voltage value of the bottom voltage signal with a voltage value of a new sensor voltage signal.

However, there is interposed, at a negative feedback portion of the operational amplifier 3B, the diode 4B which sets a direction of rectification to a backward direction with respect to a direction of input to the inverting input terminal of the operational amplifier 3B. Thus, the negative feedback portion of the operational amplifier 3B is conductive only in a case where the voltage value of the sensor voltage signal being input to the operational amplifier 3B is smaller than the voltage value of the bottom voltage signal already input to the operational amplifier 3B. In this case, the voltage value of the bottom voltage signal is replaced with the voltage value of the sensor voltage signal.

The capacitor 5B has a first electrode connected to the point B, and a second electrode connected to a grounding end. The capacitor 5B accumulates electric charges in correspondence with the voltage value of the bottom voltage signal. Therefore, while the motor is steadily driven, the voltage value of the bottom voltage signal can be kept at the minimum of the voltage value of the sensor voltage signal.

The intermediate voltage signal generator circuit 6 receives a peak voltage signal at the point P, and receives a bottom voltage signal at the point B. The intermediate voltage signal generator circuit 6 adopts an average between the voltage value of the peak voltage signal and that of the bottom voltage signal, and outputs at a point M an intermediate voltage signal having a voltage value equal to the average.

While the motor is steadily driven, the voltage value of the peak voltage signal is kept at the maximum of the voltage value of the sensor voltage signal, and the voltage value of the bottom voltage signal is kept at the minimum of the voltage value of the sensor voltage signal. Accordingly, the voltage value of the intermediate voltage signal is kept at a direct current component of the voltage value of the sensor voltage signal. With reference to FIGS. 4 to 7, described below are intermediate voltage signal generator circuits 6 according to the Configuration Examples. FIGS. 4 to 7 are diagrams respectively showing the intermediate voltage signal generator circuits 6 according to the First to Fourth Configuration Examples.

The intermediate voltage signal generator circuit 6 according to the First Configuration Example shown in FIG. 4 is configured with resistors 61P and 61B, and the like. The resistors 61P and 61B are connected in series with each other, and have resistance values equal to each other. A peak voltage signal is input to the resistor 61P, while a bottom voltage signal is input to the resistor 61B. Accordingly, an intermediate voltage signal is output at a connection point between the resistors 61P and 61B.

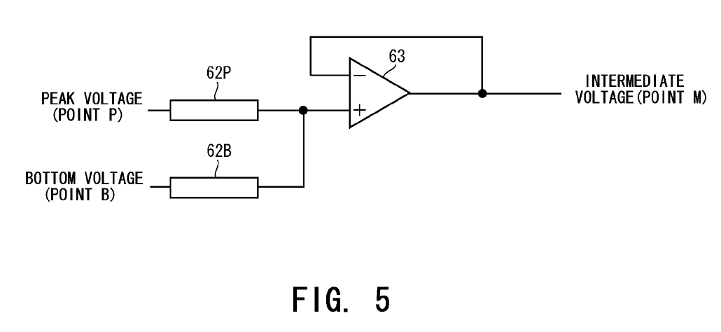

The intermediate voltage signal generator circuit 6 according to the Second Configuration Example shown in FIG. 5 is configured with resistors 62P and 62B, an operational amplifier 63, and the like. The resistors 62P and 62B are connected in series with each other, and have resistance values equal to each other. The operational amplifier 63 defines a voltage follower circuit. A peak voltage signal is input to the resistor 62P, while a bottom voltage signal is input to the resistor 62B. Accordingly, an intermediate voltage signal is output from an output terminal of the operational amplifier 63.

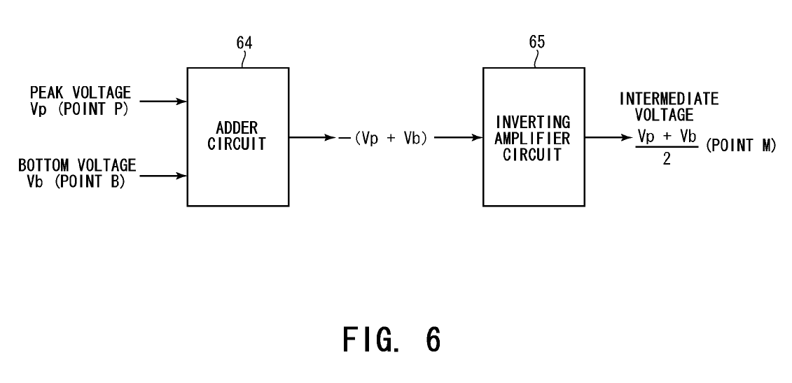

The intermediate voltage signal generator circuit 6 according to the Third Configuration Example shown in FIG. 6 is configured with an adder circuit 64, an inverting amplifier circuit 65, and the like. The adder circuit 64 receives a peak voltage signal having a voltage value Vp and a bottom voltage signal having a voltage value Vb, and outputs a voltage signal having a voltage value−(Vp+Vb). The inverting amplifier circuit 65 receives the voltage signal having the voltage value−(Vp+Vb), and outputs an intermediate voltage signal having a voltage value (Vp+Vb)/2.

In the intermediate voltage signal generator circuit 6 according to the Third Configuration Example shown in FIG. 6, an amplification factor of the adder circuit 64 is 1, while an amplification factor of the inverting amplifier circuit 65 is ½. However, the preferred embodiments of the present invention are not limited to this case. As long as a multiplication product of the amplification factor of the adder circuit 64 with the amplification factor of the inverting amplifier circuit 65 is equal to ½, an intermediate voltage signal can be generated by the adder circuit 64 and the inverting amplifier circuit 65.

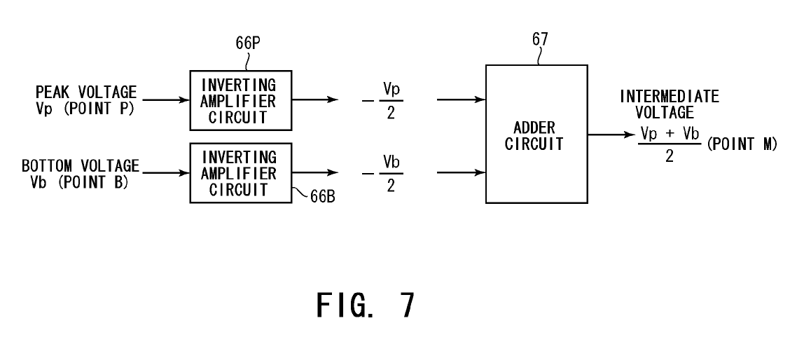

The intermediate voltage signal generator circuit 6 according to the Fourth Configuration Example shown in FIG. 7 is configured with inverting amplifier circuits 66P and 66B, an adder circuit 67, and the like. The inverting amplifier circuit 66P receives a peak voltage signal having a voltage value Vp, and outputs a voltage signal having a voltage value−Vp/2. The inverting amplifier circuit 66B receives a bottom voltage signal having a voltage value Vb, and outputs a voltage signal having a voltage value−Vb/2. The adder circuit 67 receives the voltage signal having the voltage value−Vp/2 and the voltage signal having the voltage value−Vb/2, and outputs an intermediate voltage signal having a voltage value (Vp+Vb)/2.

In the intermediate voltage signal generator circuit 6 according to the Fourth Configuration Example shown in FIG. 7, an amplification factor of each of the inverting amplifier circuits 66P and 66B preferably is ½, while an amplification factor of the adder circuit 67 preferably is 1, for example. However, the preferred embodiments of the present invention are not limited to this case. As long as the amplification factor of the inverting amplifier circuit 66P and that of the inverting amplifier circuit 66B are equal to each other and a multiplication product of the amplification factor of the inverting amplifier circuit 66P or 66B with the amplification factor of the adder circuit 67 is equal to ½, an intermediate voltage signal can be generated by the inverting amplifier circuits 66P and 66B and the adder circuit 67.

The rectangular wave voltage signal generator circuit receives a sensor voltage signal at the point S, and receives an intermediate voltage signal at the point M. The rectangular wave voltage signal generator circuit then compares a voltage value of the sensor voltage signal with a voltage value of the intermediate voltage signal, and outputs at a point R a rectangular wave voltage signal in accordance with a magnitude correlation between these voltage values.

While the motor is steadily driven, the voltage value of the sensor voltage signal is periodically varied within a constant amplitude, and the voltage value of the intermediate voltage signal is kept at the direct current component of the voltage value of the sensor voltage signal. Thus, the rectangular wave voltage signal has a duty ratio equal to 50%, so that the motor system can set a motor current value at an appropriate timing. Described below are constituents of the rectangular wave voltage signal generator circuit.

The comparator 7 receives an intermediate voltage signal at a non-inverting input terminal thereof, and receives a sensor voltage signal at an inverting input terminal thereof. The comparator 7 then compares a voltage value of the sensor voltage signal and a voltage value of the intermediate voltage signal. In a case where the voltage value of the sensor voltage signal is larger than that of the intermediate voltage signal, a corresponding rectangular wave voltage signal adopts a voltage value of a Low level. On the other hand, in a case where the voltage value of the sensor voltage signal is smaller than that of the intermediate voltage signal, the corresponding rectangular wave voltage signal adopts a voltage value of a High level.

The resistor 8 has a first end connected to the point R, and a second end connected to a constant-voltage power supply. Accordingly, the rectangular wave voltage signal adopts a constant voltage value thereof as a voltage value of the High Level.

The following is a summary of the voltage signal converter circuit according to the various preferred embodiments of the present invention. A rectangular wave voltage signal to be output from the voltage signal converter circuit is generated by comparing a magnitude correlation between the entire voltage components and a direct current voltage component of a sensor voltage signal input to the voltage signal converter circuit. The rectangular wave voltage signal desirably has a duty ratio equal to 50% so that the motor system can set a motor current value at an appropriate timing. Specifically, it is desirable that the entire voltage components respectively have sufficiently large amplitudes and that the direct current voltage component is appropriately extracted from the entire voltage components, so that the magnitude correlation between the entire voltage components and the direct current voltage component can be accurately determined.

In the voltage signal converter circuit according to the various preferred embodiments of the present invention, the entire voltage components are input directly to the inverting input terminal of the comparator 7. The direct current voltage component is input to the non-inverting input terminal of the comparator 7 not by using a high frequency filter circuit, but by using the peak hold circuit, the bottom hold circuit, and the intermediate voltage signal generator circuit 6.

Accordingly, the entire voltage components respectively have sufficiently large amplitudes independently from a frequency of the sensor voltage signal. Even in a case where the sensor voltage signal has a low frequency, the direct current voltage component is appropriately extracted from the entire voltage components without including an alternate current voltage component. In other words, since the rectangular wave voltage signal has the duty ratio equal to 50%, the motor system is capable of accurately measuring a motor driving speed and setting a motor current value at an appropriate timing even in a case where the motor driving speed is small and the sensor voltage signal has a low frequency.

### Variations of Voltage Signals Due to Driving of the Motor

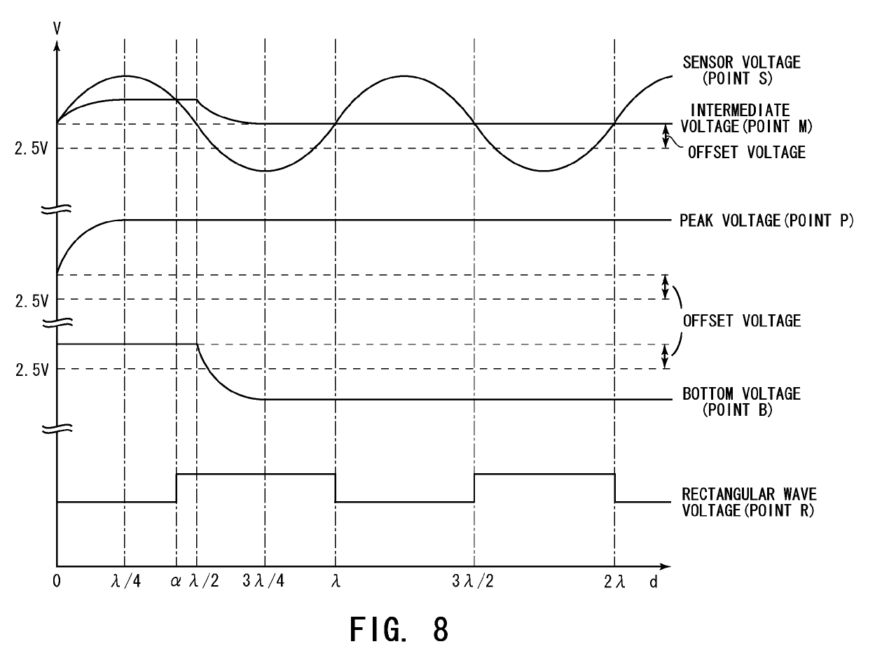

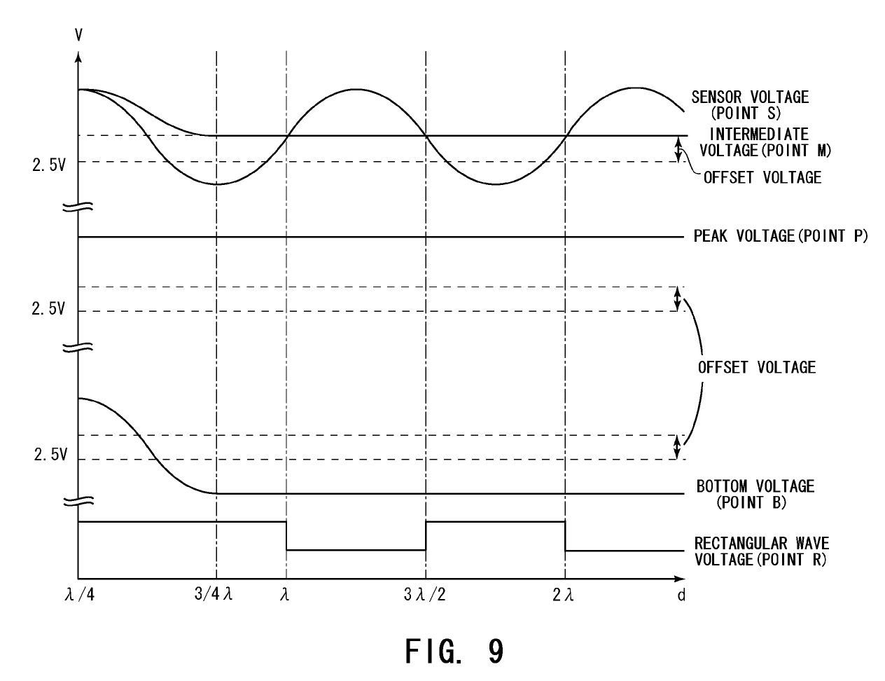

FIGS. 8 and 9 are graphs respectively showing variations of voltage signals due to driving of the motor. In FIG. 8, one arbitrary point of the sensor magnet 1 is positioned where the distance d is equal to zero when the motor starts to be driven. In FIG. 9, the arbitrary point of the sensor magnet 1 is positioned where the distance d is equal to about λ/4, for example, when the motor starts to be driven. In each of FIGS. 8 and 9, the distance d is indicated by a transverse axis, and a voltage value V of each of the voltage signals is indicated by a longitudinal axis. The distance d is increased as time passes. Specifically, the sensor magnet 1 keeps on rotating in the direction indicated by the arrow I since the motor starts to be driven.

Firstly described are the variations of the voltage signals shown in FIG. 8. When the motor starts to be driven and the arbitrary point of the sensor magnet 1 is positioned where the distance d is equal to zero, the sensor voltage signal has a voltage value equal to about 2.5 V, for example. The magnetoresistive elements 2A and 2B are not always completely identical to each other, so that the sensor voltage signal actually has a voltage value obtained by adding an offset voltage value to about 2.5 V, for example. While the sensor magnet 1 is rotating, the voltage value of the sensor voltage signal is varied within a certain amplitude around the voltage value obtained by adding the offset voltage value to about 2.5 V, for example.

When the arbitrary point of the sensor magnet 1 is positioned where the distance d is equal to zero, each of the peak voltage signal and the bottom voltage signal has a voltage value obtained by adding the offset voltage value to about 2.5 V, and the intermediate voltage signal has the voltage value obtained by adding the offset voltage value to about 2.5 V. The voltage value of the intermediate voltage signal is equal to the voltage value of the sensor voltage signal, so that the rectangular wave voltage signal has an indeterminate voltage value.

While the arbitrary point of the sensor magnet 1 travels from the position where the distance d is equal to zero to a position where the distance d is equal to about λ/4, for example, the voltage value of the sensor voltage signal is increased by the constant amplitude. That is, the sensor voltage signal keeps on updating the maximum of the voltage value. On the other hand, the sensor voltage signal never updates the minimum of the voltage value. Accordingly, the voltage value of the peak voltage signal is increased by the constant amplitude as in the voltage value of the sensor voltage signal. However, the bottom voltage signal keeps the conventional voltage value. As a result, the voltage value of the intermediate voltage signal is increased by half the constant amplitude. The voltage value of the intermediate voltage signal is smaller than the voltage value of the sensor voltage signal, so that the rectangular wave voltage signal has a voltage value of the Low level.

While the arbitrary point of the sensor magnet 1 travels from the position where the distance d is equal to about λ/4, for example, to a position where the distance d is equal to about λ/2, for example, the voltage value of the sensor voltage signal is decreased by the constant amplitude. That is, the sensor voltage signal updates none of the maximum and the minimum of the voltage value. Accordingly, each of the peak voltage signal and the bottom voltage signal keeps the conventional voltage value thereof, and the intermediate voltage signal also keeps the conventional voltage value thereof.

While the arbitrary point of the sensor magnet 1 travels from the position where the distance d is equal to about λ/4, for example, to the position where the distance d is equal to about λ/2, for example, there is a changeover in a magnitude correlation between the voltage value of the sensor voltage signal and that of the intermediate voltage signal. Suppose that the arbitrary point of the sensor magnet 1 is positioned where the distance d is equal to α when the changeover occurs in the magnitude correlation between the voltage value of the sensor voltage signal and that of the intermediate voltage signal. While the arbitrary point of the sensor magnet 1 travels from the position where the distance d is equal to about λ/4, for example, to the position where the distance d is equal to α, the voltage value of the intermediate voltage signal is smaller than the voltage value of the sensor voltage signal, so that the rectangular wave voltage signal has a voltage value of the Low level. While the arbitrary point of the sensor magnet 1 travels from the position where the distance d is equal to α to the position where the distance d is equal to about λ/2, for example, the voltage value of the intermediate voltage signal is larger than the voltage value of the sensor voltage signal, so that the rectangular wave voltage signal has a voltage value of the High level.

While the arbitrary point of the sensor magnet 1 travels from the position where the distance d is equal to about λ/2, for example, to a position where the distance d is equal to about 3λ/4, for example, the voltage value of the sensor voltage signal is decreased by the constant amplitude. Thus, the sensor voltage signal never updates the maximum of the voltage value, but keeps on updating the minimum thereof. Accordingly, the peak voltage signal keeps the conventional voltage value thereof, while the voltage value of the bottom voltage signal is decreased by the constant amplitude as in the voltage value of the sensor voltage signal. As a result, the voltage value of the intermediate voltage signal is decreased by half the constant amplitude. Specifically, the voltage value of the intermediate voltage signal returns to the value obtained by adding the offset voltage value to about 2.5 V, for example. The voltage value of the intermediate voltage signal is larger than the voltage value of the sensor voltage signal, so that the rectangular wave voltage signal has a voltage value of the High level.

While the arbitrary point of the sensor magnet 1 travels from the position where the distance d is equal to about 3λ/4, for example, to a position where the distance d is equal to about λ, for example, the voltage value of the sensor voltage signal is increased by the constant amplitude. Accordingly, the sensor voltage signal updates none of the maximum and the minimum of the voltage value. Thus, each of the peak voltage signal and the bottom voltage signal keeps the conventional voltage value thereof, and the intermediate voltage signal also keeps the conventional voltage value thereof. The voltage value of the intermediate voltage signal is larger than the voltage value of the sensor voltage signal, so that the rectangular wave voltage signal has a voltage value of the High level.

While the arbitrary point of the sensor magnet 1 travels from the position where the distance d is equal to about λ, for example, to a position where the distance d is equal to about 3λ/2, for example, the voltage value of the sensor voltage signal is varied for half a cycle. Accordingly, the sensor voltage signal updates none of the maximum and the minimum of the voltage value. Thus, each of the peak voltage signal and the bottom voltage signal keeps the conventional voltage value thereof, and the intermediate voltage signal also keeps the conventional voltage value thereof. The voltage value of the intermediate voltage signal is smaller than the voltage value of the sensor voltage signal, so that the rectangular wave voltage signal has a voltage value of the Low level.

While the arbitrary point of the sensor magnet 1 travels from the position where the distance d is equal to about 3λ/2, for example, to a position where the distance d is equal to about 2λ, for example, the voltage value of the sensor voltage signal is varied for another half a cycle. Accordingly, the sensor voltage signal updates none of the maximum and the minimum of the voltage value. Thus, each of the peak voltage signal and the bottom voltage signal keeps the conventional voltage value thereof, and the intermediate voltage signal also keeps the conventional voltage value thereof. The voltage value of the intermediate voltage signal is larger than the voltage value of the sensor voltage signal, so that the rectangular wave voltage signal has a voltage value of the High level.

In a case where the sensor magnet 1 still keeps on rotating, the variations, which are observed while the arbitrary point of the sensor magnet 1 travels from the position where the distance d is equal to about λ, for example, to the position where the distance d is equal to about 2λ, for example, repeatedly occur to the voltage signals. Specifically, the voltage value of the sensor voltage signal is varied within the constant amplitude around the voltage value obtained by adding the offset voltage value to about 2.5 V, for example. The intermediate voltage signal keeps the voltage value obtained by adding the offset voltage value to about 2.5 V, for example. The rectangular wave voltage signal adopts a voltage value either of the High level or of the Low level with the duty ratio being set to 50%.

In this preferred embodiment of the present invention, the intermediate voltage signal preferably has a voltage value obtained by adding the offset voltage value to about 2.5 V, for example, so that the rectangular wave voltage signal has the duty ratio equal to 50%. While the arbitrary point of the sensor magnet 1 travels from the position where the distance d is equal to zero to the position where the distance d is equal to about 3λ/4, for example, the voltage value of the intermediate voltage signal is not fixed to the value obtained by adding the offset voltage value to about 2.5 V, for example. However, once the arbitrary point of the sensor magnet 1 passes the position where the distance d is equal to about 3λ/4, for example, the voltage value of the intermediate voltage signal is fixed to the value obtained by adding the offset voltage value to about 2.5 V. Therefore, the motor system can accurately measure a motor driving speed, so that there arises no specific problem for setting a motor current value at an appropriate timing.

Described below are the variations of the voltage signals shown in FIG. 9. When the motor starts to be driven and the arbitrary point of the sensor magnet 1 is positioned where the distance d is equal to about λ/4, for example, the sensor voltage signal has a voltage value obtained by adding the constant amplitude as well as the offset voltage value to about 2.5 V, for example. While the sensor magnet 1 is rotating, the voltage value of the sensor voltage signal is varied within the constant amplitude around the voltage value obtained by adding the offset voltage value to about 2.5 V, for example.

When the arbitrary point of the sensor magnet 1 is positioned where the distance d is equal to about λ/4, for example, each of the peak voltage signal, the bottom voltage signal, and the intermediate voltage signal has the voltage value obtained by adding the constant amplitude as well as the offset voltage value to about 2.5 V, for example. The intermediate voltage signal has a voltage value equal to the voltage value of the sensor voltage signal, so that the rectangular wave voltage signal has an indeterminate voltage value.

While the arbitrary point of the sensor magnet 1 travels from the position where the distance d is equal to about λ/4, for example, to the position where the distance d is equal to about 3λ/4, for example, the voltage value of the sensor voltage signal is decreased by twice the constant amplitude. Accordingly, the sensor voltage signal never updates the maximum of the voltage value, but keeps on updating the minimum thereof. Thus, the peak voltage signal keeps the conventional voltage value thereof. On the other hand, the voltage value of the bottom voltage signal is decreased by twice the constant amplitude as in the voltage value of the sensor voltage signal. Therefore, the voltage value of the intermediate voltage signal is decreased by the constant amplitude. Specifically, the voltage value of the intermediate voltage signal reaches the value obtained by adding the offset voltage value to about 2.5 V, for example. The voltage value of the intermediate voltage signal is larger than the voltage value of the sensor voltage signal, so that the rectangular wave voltage signal has a voltage value of the High level.

While the arbitrary point of the sensor magnet 1 travels from the position where the distance d is equal to about 3λ/4, for example, to the position where the distance d is equal to about λ, for example, the voltage value of the sensor voltage signal is increased by the constant amplitude. Accordingly, the sensor voltage signal updates none of the maximum and the minimum of the voltage value. Thus, each of the peak voltage signal and the bottom voltage signal keeps the conventional voltage value thereof, and the intermediate voltage signal also keeps the conventional voltage value thereof. The voltage value of the intermediate voltage signal is larger than the voltage value of the sensor voltage signal, so that the rectangular wave voltage signal has a voltage value of the High level.

In a case where the sensor magnet 1 still keeps on rotating, as described with reference to FIG. 8, the variations, which are observed while the arbitrary point of the sensor magnet 1 travels from the position where the distance d is equal to about λ, for example, to the position where the distance d is equal to about 2λ, for example, repeatedly occur in the voltage signals. Once the arbitrary point of the sensor magnet 1 passes the position where the distance d is equal to about 3λ/4, for example, the voltage value of the intermediate voltage signal is fixed to the value obtained by adding the offset voltage value to about 2.5 V, for example. Therefore, the motor system can accurately measure a motor driving speed irrespective of the position of the arbitrary point of the sensor magnet 1 when the motor starts to be driven, so that no specific problem arises for setting a motor current value at an appropriate timing.

### Method for Compensating for Variations in Temperature by the Voltage Signal Converter Circuit

With regard to the variations of the voltage signals due to driving of the motor as shown in FIGS. 8 and 9, no consideration is given to a temporal variation in temperature of the motor or the like. However, in an actual magnetoresistive sensor system, a temporal variation occurs in the amplitude of the sensor voltage signal or the offset voltage value thereof because of a temporal variation in temperature of the motor.

Even in such a case, the voltage signal converter circuit is capable of accurately generating a peak voltage signal, a bottom voltage signal, an intermediate voltage signal, and a rectangular wave voltage signal. Firstly, with an assumption that the voltage signal converter circuit is incapable of compensating for a temporal variation in temperature of the motor, problems are listed in each of the following specific cases.

In a first example of the specific cases, description is given of a case where the offset voltage of the sensor voltage signal is not varied while the amplitude of the sensor voltage signal is decreased. The maximum of the voltage value of the sensor voltage signal newly input to the peak hold circuit is smaller than the voltage value of the peak voltage signal currently output from the peak hold circuit. The minimum of the voltage value of the sensor voltage signal newly input to the bottom hold circuit is larger than the voltage value of the bottom voltage signal currently output from the bottom hold circuit. Therefore, in a case where the voltage amplitude of the sensor voltage signal is decreased, none of the peak hold circuit and the bottom hold circuit can respectively update the voltage values of the peak voltage signal and the bottom voltage signal.

In a second example of the specific cases, description is given of a case where the offset voltage of the sensor voltage signal is varied in a positive direction while the amplitude of the sensor voltage signal is not varied. The maximum of the voltage value of the sensor voltage signal newly input to the peak hold circuit is larger than the voltage value of the peak voltage signal currently output from the peak hold circuit. The minimum of the voltage value of the sensor voltage signal newly input to the bottom hold circuit is larger than the voltage value of the bottom voltage signal currently output from the bottom hold circuit. Therefore, in a case where the offset voltage of the sensor voltage signal is varied in the positive direction, the peak hold circuit is capable of updating the voltage value of the peak voltage signal, but the bottom hold circuit is incapable of updating the voltage value of the bottom voltage signal.

Description is given next to a method in accordance with which the voltage signal converter circuit is capable of accurately generating a rectangular wave voltage signal even in a case where the amplitude of the sensor voltage signal or the offset voltage thereof is varied. Specifically, the voltage signal converter circuits according to the First and Second Configuration Examples respectively shown in FIGS. 2 and 3 are described below in this order. The following description refers to a case of using the intermediate voltage signal generator circuit 6 according to the First Configuration Example shown in FIG. 4.

In the voltage signal converter circuit according to the First Configuration Example shown in FIG. 2, the voltage value of the peak voltage signal output at the point P is larger than the voltage value of the bottom voltage signal output at the point B. Accordingly, the capacitor 5P discharges electricity to the point B through the intermediate voltage signal generator circuit 6, and the capacitor 5B charges electricity from the point P through the intermediate voltage signal generator circuit 6. In other words, the intermediate voltage signal generator circuit 6 is in charge of discharging electricity at the capacitor 5P and charging electricity at the capacitor 5B, as well as generating an intermediate voltage signal in accordance with a peak voltage signal and a bottom voltage signal.

While the capacitor 5P discharges electricity, the voltage value of the peak voltage signal output at the point P is decreased. Specifically, while the peak hold circuit operates to increase the voltage value of the peak voltage signal, the intermediate voltage signal generator circuit 6 operates to decrease the voltage value of the peak voltage signal. Therefore, an accurate peak voltage signal is generated by cooperation between the peak hold circuit and the intermediate voltage signal generator circuit 6.

While the capacitor 5B charges electricity, the voltage value of the bottom voltage signal output at the point B is increased. Specifically, while the bottom hold circuit operates to decrease the voltage value of the bottom voltage signal, the intermediate voltage signal generator circuit 6 operates to increase the voltage value of the bottom voltage signal. Therefore, an accurate bottom voltage signal is generated by cooperation between the bottom hold circuit and the intermediate voltage signal generator circuit 6.

As described above, the voltage signal converter circuit according to the First Configuration Example shown in FIG. 2 is capable of generating an accurate rectangular wave voltage signal even in a case where a temporal variation occurs to the amplitude of the sensor voltage signal or the offset voltage thereof because of a temporal variation in the temperature of the motor.

The voltage signal converter circuit according to the First Configuration Example shown in FIG. 2 desirably generates an accurate rectangular wave voltage signal by compensating for the temporal variation in the temperature of the motor. For such a purpose, it is desirable that a time constant, which is determined by electrostatic capacitances of the capacitors 5P and 5B as well as resistance values of the resistors 61P and 61B, is sufficiently small in comparison to a time scale of the variation in temperature of the motor or the like.

In the voltage signal converter circuit according to the Second Configuration Example shown in FIG. 3, the resistors 9P and 9B are additionally provided as constituents to the voltage signal converter circuit according to the First Configuration Example shown in FIG. 2. The resistor 9P has a first end connected the point P and a second end connected to a grounding end. The resistor 9B has a first end connected to the point B and a second end connected to an end to which a constant-voltage power supply applies a constant voltage.

As the peak voltage signal output at the point P has a voltage value sufficiently larger than a ground voltage value, the capacitor 5P discharges electricity to the grounding end. Further, as the bottom voltage signal output at the point B has a voltage value sufficiently smaller than the constant voltage value applied by the constant-voltage power supply, the capacitor 5B charges electricity from the end to which the constant-voltage power supply applies the constant voltage.

In order that the capacitor 5P discharges electricity, the second end of the resistor 9P is not necessarily connected to the grounding end, but may be applied with a voltage smaller than the bottom voltage. Similarly, in order that the capacitor 5B charges electricity, the second end of the resistor 9B is not necessarily connected to the end to which the constant-voltage power supply applies the constant voltage, but may be applied with a voltage larger than the peak voltage. Further, it is desirable that a time constant, which is determined by electrostatic capacitances of the capacitors 5P and 5B as well as resistance values of the resistors 9P and 9B, is sufficiently small in comparison to the time scale of the variation in temperature of the motor or the like.

In order that each of the voltage signal converter circuits according to the First and Second Configuration Examples respectively shown in FIGS. 2 and 3 generates a more accurate rectangular wave voltage signal, it is desirable to decrease as much as possible an input offset voltage with respect to the operational amplifiers 3P and 3B as well as the comparator 7. It is also desirable that the resistors 61P and 61B have resistance values as equal as possible with each other.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A voltage signal converter circuit arranged to receive, from a magnetoresistive sensor arranged to sense a magnetic field generated by a magnet having a plurality of magnetic poles, a sensor voltage signal in accordance with a variation in the magnetic field due to a variation in a relative position between the magnet and the magnetoresistive sensor to convert the sensor voltage signal to a rectangular wave voltage signal, the voltage signal converter circuit comprising:
a peak hold circuit arranged to adopt a maximum of a voltage value of the sensor voltage signal input from the magnetoresistive sensor and output a peak voltage signal having a voltage value equal to the maximum;
a bottom hold circuit arranged to adopt a minimum of the voltage value of the sensor voltage signal input from the magnetoresistive sensor and output a bottom voltage signal having a voltage value equal to the minimum;
an intermediate voltage signal generator circuit arranged to output an intermediate voltage signal having a voltage value equal to an average between the voltage value of the peak voltage signal input from the peak hold circuit and the voltage value of the bottom voltage signal input from the bottom hold circuit; and
a rectangular wave voltage signal generator circuit arranged to output the rectangular wave voltage signal in accordance with a magnitude correlation between the voltage value of the sensor voltage signal input from the magnetoresistive sensor and the voltage value of the intermediate voltage signal input from the intermediate voltage signal generator circuit.

2. The voltage signal converter circuit according to claim 1, wherein the peak hold circuit includes:
a calculation amplifier arranged to receive the sensor voltage signal at a non-inverting input terminal;
a rectifier arranged to set a direction of rectification at a negative feedback portion of the calculation amplifier to a forward direction with respect to a direction of input to an inverting input terminal; and
a capacitor arranged to accumulate electric charges in correspondence with the voltage value of the peak voltage signal.

3. The voltage signal converter circuit according to claim 1, wherein the bottom hold circuit includes:
a calculation amplifier arranged to receive the sensor voltage signal at a non-inverting input terminal;
a rectifier arranged to set a direction of rectification at a negative feedback portion of the calculation amplifier to a backward direction with respect to a direction of input to an inverting input terminal; and
a capacitor arranged to accumulate electric charges in correspondence with the voltage value of the bottom voltage signal.

4. The voltage signal converter circuit according to claim 1, wherein the intermediate voltage signal generator circuit includes a voltage divider circuit having two resistors which have resistance values equal to each other and are connected in series, and the voltage divider circuit includes:
an input unit arranged to receive the peak voltage signal at a first input terminal;
an input unit arranged to receive the bottom voltage signal at a second input terminal; and
an output unit arranged to output the intermediate voltage signal at a connection point between the two resistors.

5. The voltage signal converter circuit according to claim 1, wherein the rectangular wave voltage signal generator circuit includes a comparator circuit arranged to compare the voltage value of the sensor voltage signal with the voltage value of the intermediate voltage signal, and the comparator circuit includes:
an input unit arranged to receive the sensor voltage signal at a first input terminal;
an input unit arranged to receive the intermediate voltage signal at a second input terminal; and
an output unit arranged to output the rectangular wave voltage signal at an output terminal.

6. The voltage signal converter circuit according to claim 1, further comprising:
a voltage value decreasing unit arranged to decrease the voltage value of the peak voltage signal; and
a voltage value increasing unit arranged to increase the voltage value of the bottom voltage signal.

7. The voltage signal converter circuit according to claim 6, wherein the voltage value decreasing unit includes a control unit arranged to control the voltage value such that a speed of decrease in the voltage value of the peak voltage signal due to a variation in temperature is larger than a speed of increase in the voltage value of the peak voltage signal.

8. The voltage signal converter circuit according to claim 6, wherein the voltage value increasing unit includes a control unit arranged to control the voltage value such that a speed of increase in the voltage value of the bottom voltage signal due to a variation in temperature is larger than a speed of decrease in the voltage value of the bottom voltage signal.

9. The voltage signal converter circuit according to claim 2, further comprising a voltage value decreasing unit arranged to decrease the voltage value of the peak voltage signal, wherein the voltage value decreasing unit includes a decreasing unit arranged to decrease the voltage value of the peak voltage signal by discharging electric charges from the capacitor to an end having a voltage value smaller than the voltage value of the peak voltage signal.

10. The voltage signal converter circuit according to claim 9, wherein the end having a smaller voltage includes an end from which the bottom voltage signal is output.

11. The voltage signal converter circuit according to claim 9, wherein the end having a smaller voltage includes an end applied with a voltage having a voltage value smaller than the voltage value of the bottom voltage signal.

12. The voltage signal converter circuit according to claim 9, wherein the voltage value decreasing unit includes a control unit arranged to control the voltage value such that a speed of decrease in the voltage value of the peak voltage signal due to a variation in temperature is larger than a speed of increase in the voltage value of the peak voltage signal.

13. The voltage signal converter circuit according to claim 3, further comprising a voltage value increasing unit arranged to increase the voltage value of the bottom voltage signal, wherein the voltage value increasing unit includes an increasing unit arranged to increase the voltage value of the bottom voltage signal by charging electric charges to the capacitor from an end having a voltage value larger than the voltage value of the bottom voltage signal.

14. The voltage signal converter circuit according to claim 13, wherein the end having a larger voltage includes an end from which the peak voltage signal is output.

15. The voltage signal converter circuit according to claim 13, wherein the end having a larger voltage includes an end applied with a voltage having a voltage value larger than the voltage value of the peak voltage signal.

16. The voltage signal converter circuit according to claim 13, wherein the voltage value increasing unit includes a control unit arranged to control the voltage value such that a speed of increase in the voltage value of the bottom voltage signal due to a variation in temperature is larger than a speed of decrease in the voltage value of the bottom voltage signal.

17. A motor comprising the voltage signal converter circuit according to claim 1.
